(19) United States
(12) Patent Application Publication
(10) Pub. No.: US 2004/0224550 A1
(43) Pub. Date: Nov. 11, 2004

(54) Plug-in unit insertion guide mechanism

(75) Inventor: Shintaro Fujioka, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/834,197

(22) Filed: Apr. 29, 2004

(30) Foreign Application Priority Data
May 6, 2003 (JP) 2003-128092

(51) Int. Cl. H01R 13/64

(52) U.S. Cl. 439/378

(57) ABSTRACT

An insertion guide mechanism for use when inserting a plug-in unit for connection to a motherboard implemented on a sub-rack is provided to realize a highly accurate positioning during the plug-in unit insertion process, by forming a guide strip which extends toward the plug-in unit integrally with a warp preventive part provided on the motherboard; providing a slit section into which the guide strip is to be inserted without any clearance on a printed wiring board which comprises the plug-in unit; making the thickness dimension of the guide strip and the width dimension of the slit section quasi-equal to each other with great precision; and forming tapered sections on both sides of the mouth of the slit section to guide insertion of the guide strip.

### BACKGROUNDS OF THE INVENTION

1. Field of the Invention

The present invention relates to an insertion guide mechanism which guides insertion of a plug-in unit into the motherboard housed in the sub-rack of an electronics device. More particularly, the present invention relates to a plug-in unit insertion guide mechanism which enables a plug-in unit to be guided for insertion with greater precision, without needing any additional part specially for this purpose.

2. Description of the Related Art

For many devices, notably communications and other electronics devices, a typical conventional approach to extending their functionality is to connect plug-in units that can implement desired functions to the motherboard placed in the rack of the device enclosure. These plug-in units are connected in a removable manner to the motherboard of the electronics device as necessary.

Connection of a plug-in unit can be achieved by first inserting the plug-in unit into a guide rail provided on the rack and then pushing the plug-in unit toward the motherboard with a pre-determined force until the connector of the plug-in unit (receptacle) is engaged with the corresponding plug connector of the motherboard.

However, a recent trend toward higher-density implementations has created two problems for this connection method. Firstly, the number of pins in a connector which connects between a plug-in unit and the motherboard is increasing to meet the needs of higher-density implementations. This means that a much greater force is needed for a connector to be fully engaged with its mate. Secondly, along with the increase in the number of pins, each pin in a connector has become thinner and weaker. As a result, greater positioning precision is called for during the insertion process for a plug-in unit.

If a plug-in unit is pushed hard when it is not positioned correctly, the connector will very often fail to be engaged with its mate properly. In some cases, the connector may be damaged as a result of its pins being bent.

Moreover, to achieve its functions, a plug-in unit may require to be connected at a specific position on the motherboard. Therefore, in ensuring proper operation of a device, it is critical to provide a preventive measure against misinsertion of plug-in units.

Examples of conventional mechanisms to prevent misinsertion of a plug-in unit into a motherboard or the like include those disclosed in Japanese Patent Laying-Open (Kokai) No. Heisei 6-6054 (Reference 1) and No. Heisei 8-162783 (Reference 2). In these mechanisms, either a guide pin or a guide hole is provided on the unit side. On the receiving side, a guide hole into which the unit's guide pin fits, or a guide pin which fits into the unit's guide hole, is provided as appropriate.

Another example is the one disclosed in Japanese Patent Laying-Open (Kokai) No. 2002-329984 (Reference 3). This mechanism prevents misinsertion by providing a reinforcing member on the backboard (motherboard) and a concave groove in the printed circuit board that constitutes a plug-in unit.

As stated above, the increased number of pins in a connector has led to a correspondingly larger force required and a reduction in the thickness and strength of each pin in the connector. As shown in References 1 to 3, although the conventional mechanisms provide various features to prevent misinsertion of a plug-in unit, these mechanisms typically fail to address the need of serving as a guide to ensure highly precise positioning of a plug-in unit.

Moreover, the misinsertion preventive mechanisms shown in References 1 and 2 require additional parts specially for this purpose, leading to an increase in cost.

### SUMMARY OF THE INVENTION

One object of the present invention is to provide a plug-in unit insertion guide mechanism which can enable a plug-in unit to be positioned for insertion with great precision and which can be implemented cost effectively by eliminating the need to add new parts specially for this purpose.

Another object of the present invention is to propose a plug-in unit insertion guide mechanism which can not only serve as a positioning mechanism but also as a misinsertion preventive mechanism during the plug-in unit insertion process.

According to the first aspect of the invention, a plug-in unit insertion guide mechanism which assists insertion of a plug-in unit for connection to a motherboard on a sub-rack, wherein a guide strip which extends toward the plug-in unit is formed integrally with a reinforcing member provided on the motherboard, and a slit section into which the guide strip is to be inserted without any clearance is provided on a printed wiring board which comprises the plug-in unit.

According to another aspect of the invention, a sub-rack provided with a plug-in unit insertion guide mechanism which assists insertion of a plug-in unit for connection to a motherboard on a sub-rack, wherein the insertion guide mechanism comprises a guide strip which is formed integrally with a reinforcing member provided on the motherboard and which extends toward the plug-in unit, and a slit section which is provided on a printed wiring board which comprises the plug-in unit and into which the guide strip is to be inserted without any clearance.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is an outline drawing which shows how a plug-in unit is inserted into the motherboard when a plug-in unit insertion guide mechanism according to the first embodiment of the present invention is applied;

FIG. 2 is a partially enlarged drawing which shows a part of the constitution of the insertion guide mechanism according to the first embodiment of the present invention;

FIG. 3 is a partially enlarged drawing which shows the constitution of the guide strip of the warp preventive part and that of the slit section of the plug-in unit according to the first embodiment;

FIG. 4 is a side-view drawing which shows the state of the plug-in unit of the first embodiment at the start of the insertion process;

FIG. 5 is a partially enlarged drawing which shows the state of the plug-in unit in FIG. 4 at the start of the insertion process;

FIG. 6 is a partially enlarged drawing which shows the state of the ejector while the plug-in unit in FIG. 4 is in the state at the start of the insertion process;

FIG. 7 is a side-view drawing which shows the state of the plug-in unit of the first embodiment at the completion of the insertion process;

FIG. 8 is a side-view drawing which shows the state of the plug-in unit of the first embodiment when it has been misinserted;

FIG. 9 is a partially enlarged drawing which shows a part of the constitution of the insertion guide mechanism according to the second embodiment of the present invention; and

FIG. 10 is a partially enlarged drawing which shows a part of the constitution of the insertion guide mechanism according to the third embodiment of the present invention.

### DESCRIPTION OF THE PREFERRED EMBODIMENTS

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

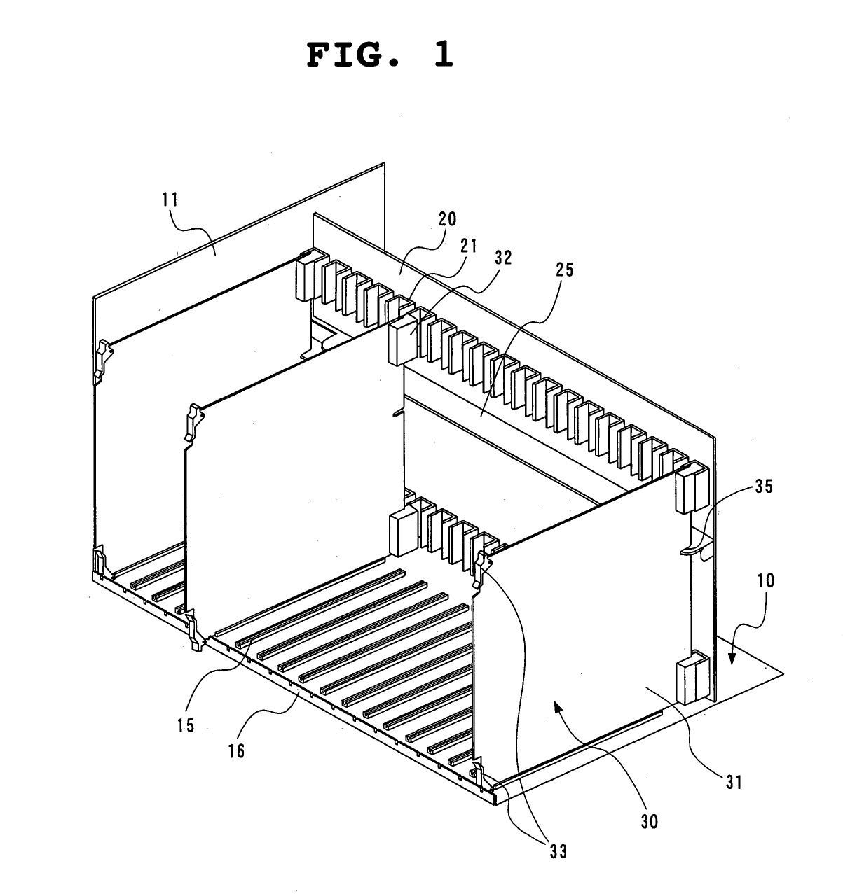

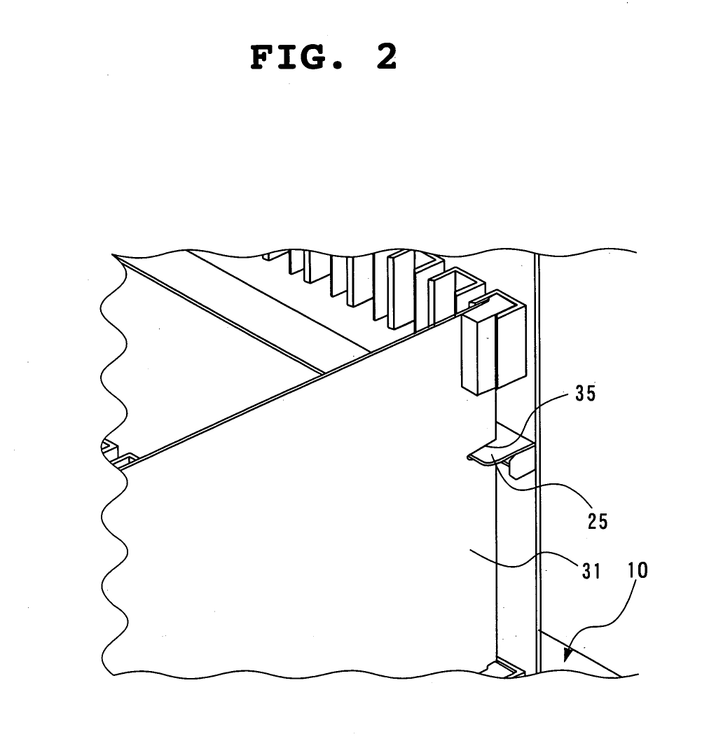

The embodiments of the present invention will now be described in detail by referring to the drawings. FIG. 1 is an outline drawing which shows a plug-in unit connected to the motherboard by applying the insertion guide mechanism according to the first embodiment of the present invention. FIG. 2 is its partially enlarged drawing.

In FIG. 1 and FIG. 2, 10 is a sub-rack (or a shelf) of an electronics device, 20 is a motherboard implemented on the sub-rack 10, and 30 is a plug-in unit inserted for connection with the motherboard 20.

The plug-in unit 30 primarily consists of a printed wiring board 31 and an ejector 33. The ejector 33 is an insert/remove lever, which is used to insert or remove the connector 32 implemented on the printed wiring board 31 and the printed wiring board 31. The sub-rack 10 is an enclosure which houses multiple plug-in units 30.

Due to a recent trend toward higher-density implementations, the number of pins in a connector used for connection between a plug-in unit 30 and a motherboard 20 is increasing. This means that a greater force is required to engage a connector with its mate. More specifically, a force of approximately 45 gf is required per pin to engage a connector with its mate. For example, a plug-in unit 30 with 1000 pins would require a force of approximately 45 kgf in total.

While a plug-in unit 30 is being inserted for connection, this amount of force will be applied to the motherboard 20; in some cases, the motherboard 20 may be warped because it cannot support this amount of force alone. If the implementation of the plug-in unit 30 is completed with the motherboard 20 in a warped state, the connectors of the plug-in unit 30 and the motherboard 20 may not be connected firmly (i.e., “loose contact”), resulting in an unstable electric connection between the plug-in unit 30 and the motherboard 20.

A common approach to avoiding such a problem is to provide on the motherboard 20 a part which can serve as a warp preventive measure to achieve proper connection of a plug-in unit 30. The motherboard 20 of this embodiment as well is provided with a warp preventive part 25 for the prevention of warping.

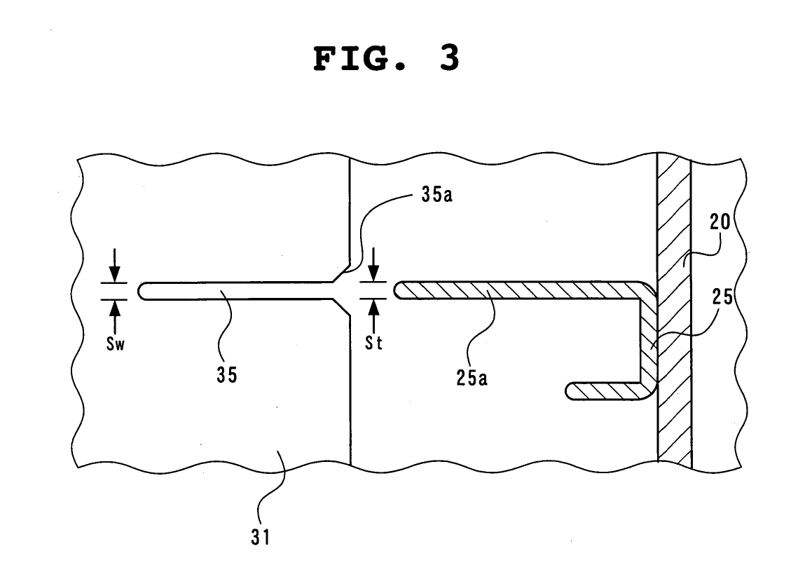

As shown in FIG. 3, the cross section of this warp preventive part 25 is formed to have a shape roughly similar to an angular U-letter. Either of the horizontal portions of this shape is then made longer than the other to overhang toward the plug-in unit 30 to form a guide strip 25a (the upper one in FIG. 3).

In the back face of the printed wiring board 31, which is part of the plug-in unit 30, a slit section 35 is formed into which the guide strip 25a of the above-described warp preventive part 25 will be engaged.

The guide strip 25a and the slit section 35 together form an insertion guide mechanism to guide a plug-in unit 30 accurately by adjusting vertical and horizontal deviations while it is being inserted.

In this mechanism, the distance between the guide strip 25a and its connector (receptacle) of the warp preventive part 25 on the motherboard 20 is made to be equal with sufficiently high precision to the distance between the slit section 35 and its connector (plug) 32 of the plug-in unit 30.

Also as shown in FIG. 3, the thickness St of the guide strip 25a and the width Sw of the slit section 35 of the warp preventive part 25 are formed to be quasi-equal to each other, so that the guide strip 25a will be engaged into the slit section 35 to a great precision without leaving any unwanted clearance in between.

The upper and lower sections of the mouth of the slit section 35 is provided with a tapered section, respectively, so that the mouth is wider toward the outside.

The slit section 35 and the tapered sections 35a are created simultaneously with the outside shape of the printed wiring board 31, which is part of the plug-in unit 30, is formed.

As a result of forming the guide strip 25a of the warp preventive part 25 and the slit section 35 with great precision such that the thickness St of the guide strip 25a and the width Sw of the slit section 35 will be quasi-equal to each other, any deviation in the position of the guide strip 25a of the warp preventive part 25 from that of the slit section 35, however it may be small, would make it extremely difficult to engage the slit section 35 into the guide strip 25a properly when inserting the plug-in unit 30.

This problem can be solved by providing the tapered sections 35a as described above, as this embodiment does. These tapered sections allow the guide strip 25a of the warp preventive part 25 to be inserted smoothly into the slit section 35, even if the guide strip 25a is slightly deviated in position from the slit section 35.

The tapered sections 35a can achieve similarly smooth insertion even when the guide strip 25a and the slit section 35 are formed to be equal to each other in size with great precision.

The sub-rack 10, into which the plug-in unit 30 is designed to be inserted, is provided with the guide rail 15, as shown in FIG. 1, which can prevent side-to-side deviations (in the horizontal direction) by guiding the plug-in unit 30 in the vertical direction during the insertion process.

By using the constitution as described above, the connector 32 of the plug-in unit 30 can be engaged into the connector 21 of the motherboard 20 for proper connection. This is because, after the plug-in unit 30 begins to be inserted and just before its connector 32 is connected with the connector 21 of the mother board 20, the above-described guide strip 25a will be engaged into the slit section 35 of the plug-in unit 30, thereby causing the plug-in unit 30 being inserted to be guided accurately in both the vertical and horizontal directions and finally to be positioned with great precision.

Furthermore, the guide strip 25a of the warp preventive part 25 is designed to have a length such that the engagement between the connector 21 of the motherboard 20 and the connector 32 of the plug-in unit 30 can be prevented if the plug-in unit 30 is misinserted because the tip of the guide strip 25a will collide with any section of the printed wiring board 31 other than the slit section 35.

As described in the foregoing, by providing the guide strip 25a of the warp preventive part 25 and the slit section 35 of the plug-in unit 30, a mechanism can be realized which can function as both an insertion guide mechanism to insert the plug-in unit 30 with great precision and a misinsertion preventive mechanism to prevent the plug-in unit 30 from being misinserted.

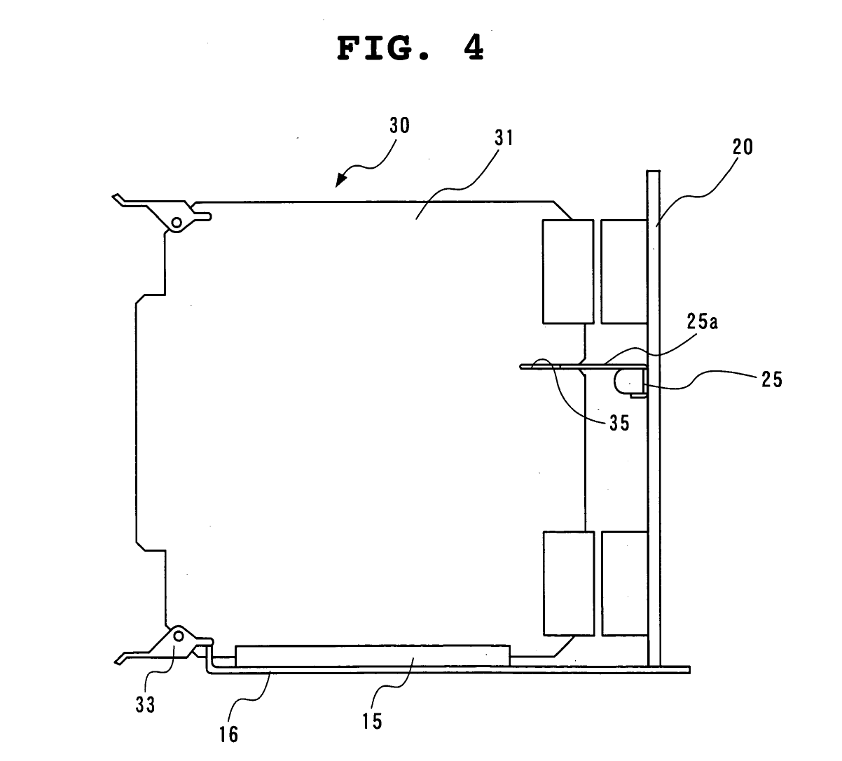

With reference to FIGS. 4 to 8, the procedure to connect a plug-in unit 30 to the motherboard 20 on the sub-rack 10 will now be described.

When a plug-in unit 30 is implemented on the sub-rack 10, the plug-in unit 30 is usually inserted to fit into the guide rail 15 provided on the sub-rack 10.

As the insertion process progresses, the upper jaw of the ejector 33 provided on the plug-in unit 30 comes to rest on the erected piece 16 provided in front of the guide rail 15 of the sub-rack 10, as shown in FIG. 4.

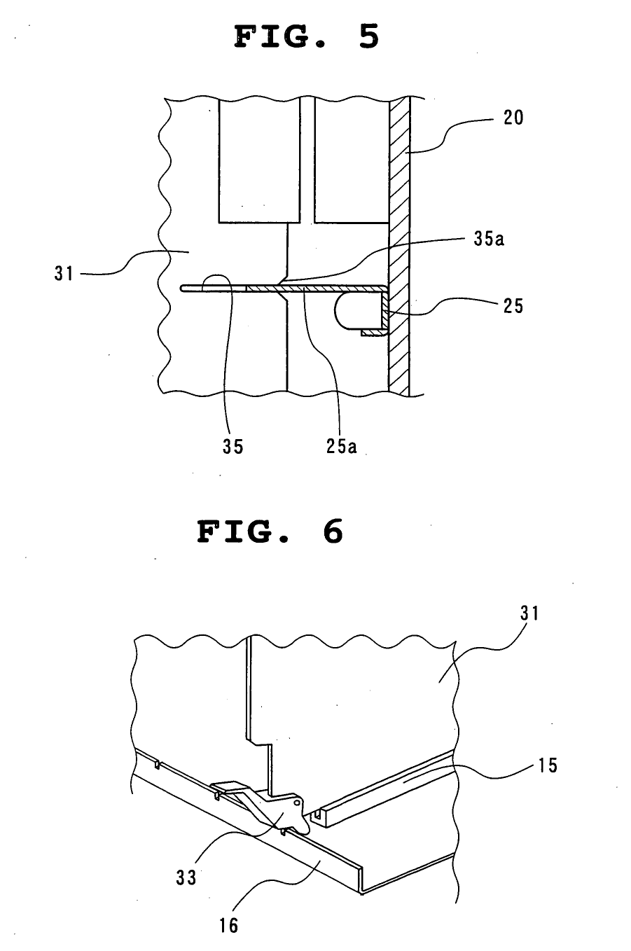

At this stage, as shown in FIGS. 4 and 5, the tip of the guide strip 25a of the warp preventive part 25 is inserted slightly into the slit section 35. The connector 32 of the plug-in unit 30 has not been engaged yet but is positioned slightly away from the connector 21 of the motherboard 20.

When in this state the lever, which is the point of force of the ejector 33 of the plug-in unit 30, is raised up, the ejector 33 will rotate around the tip of its upper jaw and the upper jaw will hit the erected piece 16, as shown in FIG. 6.

This action causes a force toward the motherboard 20 to be applied to the rotating pin supporting the ejector 33. Along with this, the guide strip 25a of the warp preventive part 25 is inserted into the slit section 35 of the plug-in unit 30, making the plug-in unit 30 move toward the motherboard 20.

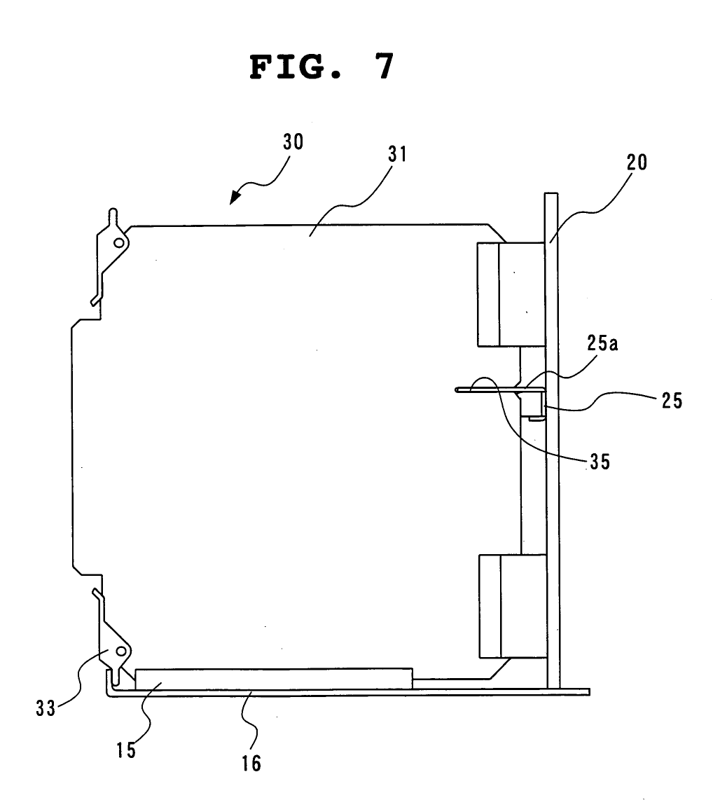

As a result, as shown in FIG. 7, the plug-in unit 30 is positioned with great precision by being guided accurately in both the vertical and horizontal directions while it is being inserted, and proper connection is then achieved when the connector (receptacle) 21 provided on the motherboard 20 and the connector (plug) 32 provided on the plug-in unit 30 are engaged with each other.

Even when the plug-in unit 30 is displaced slightly in the vertical direction at the beginning of inserting the plug-in unit 30, the guide strip 25a will be guided by the tapered sections 35a of the slit section 35 as the insertion process progresses and will eventually be engaged properly into the slit section 35 without fail.

As shown in FIGS. 4 and 7, this embodiment has a constitution which can ensure that the connectors of the plug-in unit 30 and the motherboard 20 will be engaged with each other only if the position of the slit section 35 provided on the back face of the plug-in unit 30 matches that of the guide strip 25a of the warp preventive part 25 of the motherboard 20 provided on the sub-rack 10.

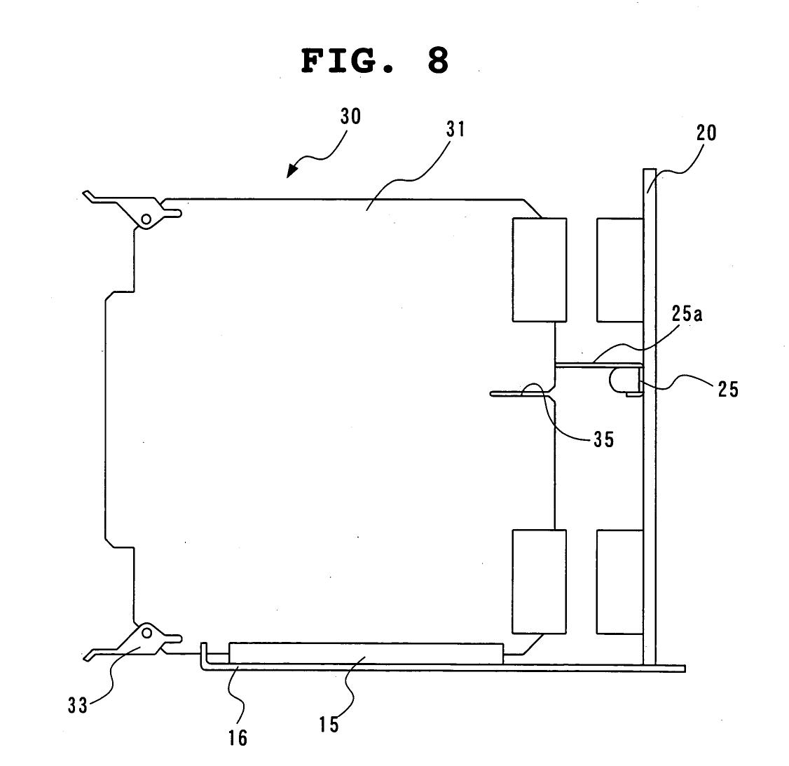

Conversely, as shown in FIG. 8, if the position of the slit section 35 of the plug-in unit 30 does not match that of the guide strip 25a of the warp preventive part 25, the tip of the guide strip 25a will collide with the end face of the printed wiring board 31, thereby preventing the plug-in unit 30 from moving toward the motherboard 20. The connectors will thus be prevented from coming into contact with each other.

In summary, if the insertion process progresses normally, the insertion of the plug-in unit 30 can be achieved because the above-mentioned guide strip 25a is engaged into the slit section 35 of the plug-in unit 30. In case the plug-in unit 30 should be misinserted, then the plug-in unit 30 will be prevented from being inserted because a section other than the slit section 35 of the printed wiring board 31 will collide with the guide strip 25a.

FIG. 9 shows an insertion guide mechanism according to the second embodiment of the present invention. While the first embodiment described above uses a guide strip 25a formed in the horizontal section on the upper side of the warp preventive part 25, it is possible, as shown in FIG. 9, to form a guide strip 25a in the horizontal section on the lower side (instead of the upper side) of the warp preventive part 25. In this case, the slit section 35 of the plug-in unit is provided at a position corresponding to that of the guide strip 25a.

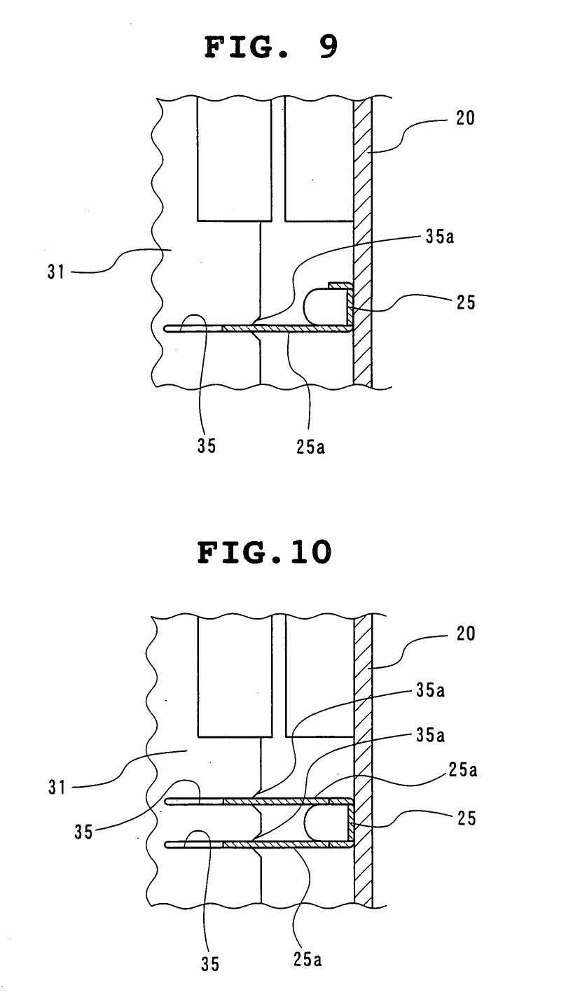

FIG. 10 shows an insertion guide mechanism according to the third embodiment of the present invention. As shown in FIG. 10, the third embodiment is constituted such that two guide strips 25a are formed in the upper and lower horizontal sections, respectively, and that two slit sections 35 are provided on the plug-in unit 30 at corresponding positions.

Thus, by providing two strips 25a and two slit sections 35, an even higher guiding precision can be achieved by these guide strips 25a and slit sections 35.

While the present invention has been described by taking preferred embodiments and actions as examples, it should be noted that the present invention is not limited to the preferred embodiments and actions described above and that it can be implemented with a variety of modifications without departing from the spirit and scope of its technical principle.

The embodiments described above have a constitution in which a guide strip 25a is formed on a warp preventive part 25 provided on the motherboard 20. However, in addition to forming a guide strip 25a on a warp preventive part 25, it is possible to form a guide strip 25a on not only on a warp preventive part but also on any other reinforcing member provided on the motherboard 20.

As is clear from the descriptions above, by adopting a plug-in unit insertion guide mechanism according to the present invention, a number of outstanding effects can be achieved, as follows:

Firstly, the slit section of a plug-in unit and the warp preventive part of the motherboard allow the plug-in unit to be positioned with great precision while the plug-in unit is being inserted.

This highly accurate positioning makes it possible to connect the connectors with each other properly and prevent the connectors from being damaged as a result of their pins being bent.

Secondly, since this invention is made up of the slit section of a plug-in unit and the warp preventive part of the motherboard, it is possible to realize an insertion guide mechanism cost effectively without needing to add a new part specially for this purpose.

Thirdly, this invention can function not only as a positioning mechanism for the insertion of a plug-in unit but also as a misinsertion preventive mechanism to prevent the misinsertion of a plug-in unit.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A plug-in unit insertion guide mechanism which assists insertion of a plug-in unit for connection to a motherboard on a sub-rack, wherein:
a guide strip which extends toward said plug-in unit is formed integrally with a reinforcing member provided on said motherboard, and
a slit section into which said guide strip is to be inserted without any clearance is provided on a printed wiring board which comprises said plug-in unit.

2. The insertion guide mechanism as set forth in claim 1, wherein:
said guide strip is to be inserted into the slit section of said printed wiring board without any clearance.

3. The insertion guide mechanism as set forth in claim 1, wherein:
the thickness dimension of said guide strip and the width dimension of said slit section are made to be quasi-equal to each other with great precision.

4. The insertion guide mechanism as set forth in claim 1, wherein:
tapered sections to guide insertion of said guide strip are formed on both sides of the mouth of said slit section.

5. The insertion guide mechanism as set forth in claim 1, wherein:
the thickness dimension of said guide strip and the width dimension of said slit section are made to be quasi-equal to each other with great precision, and
tapered sections to guide insertion of said guide strip are formed on both sides of the mouth of said slit section.

6. The insertion guide mechanism as set forth in claim 1, wherein:
said guide strip is formed by forming said reinforcing member of said motherboard to have a cross-sectional shape roughly similar to an angular U-letter and then protruding the horizontal section of said reinforcing member toward said plug-in unit.

7. The insertion guide mechanism as set forth in claim 1, wherein:
the thickness dimension of said guide strip and the width dimension of said slit section are made to be quasi-equal to each other with great precision, and
said guide strip is formed by forming said reinforcing member of said motherboard to have a cross-sectional shape roughly similar to an angular U-letter and then making the horizontal section of said reinforcing member protrude toward said plug-in unit.

8. The insertion guide mechanism as set forth in claim 1, wherein:
tapered sections to guide insertion of said guide strip are formed on both sides of the mouth of said slit section, and
said guide strip is formed by forming said reinforcing member of said motherboard to have a cross-sectional shape roughly similar to an angular U-letter and then protruding the horizontal section of said reinforcing member toward said plug-in unit.

9. The insertion guide mechanism as set forth in claim 1, wherein:
the thickness dimension of said guide strip and the width dimension of said slit section are made to be quasi-equal to each other with great precision, and
tapered sections to guide insertion of said guide strip are formed on both sides of the mouth of said slit section, and
said guide strip is formed by forming said reinforcing member of said motherboard to have a cross-sectional shape roughly similar to an angular U-letter and then protruding the horizontal section of said reinforcing member toward said plug-in unit.

10. The insertion guide mechanism as set forth in claim 1, wherein:
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

11. The insertion guide mechanism as set forth in claim 1, wherein:
the thickness dimension of said guide strip and the width dimension of said slit section are made to be quasi-equal to each other with great precision, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

12. The insertion guide mechanism as set forth in claim 1, wherein:
tapered sections to guide insertion of said guide strip are formed on both sides of the mouth of said slit section, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

13. The insertion guide mechanism as set forth in claim 1, wherein:
the thickness dimension of said guide strip and the width dimension of said slit section are made to be quasi-equal to each other with great precision,
tapered sections to guide insertion of said guide strip are formed on both sides of the mouth of said slit section, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

14. The insertion guide mechanism as set forth in claim 1, wherein:
said guide strip is formed by forming said reinforcing member of said motherboard to have a cross-sectional shape roughly similar to an angular U-letter and then protruding the horizontal section of said reinforcing member toward said plug-in unit, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

15. The insertion guide mechanism as set forth in claim 1, wherein:
the thickness dimension of said guide strip and the width dimension of said slit section are made to be quasi-equal to each other with great precision,
said guide strip is formed by forming said reinforcing member of said motherboard to have a cross-sectional shape roughly similar to an angular U-letter and then protruding the horizontal section of said reinforcing member toward said plug-in unit, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

16. The insertion guide mechanism as set forth in claim 1, wherein:
tapered sections to guide insertion of said guide strip are formed on both sides of the mouth of said slit section,
said guide strip is formed by forming said reinforcing member of said motherboard to have a cross-sectional shape roughly similar to an angular U-letter and then protruding the horizontal section of said reinforcing member toward said plug-in unit, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

17. The insertion guide mechanism of claim 1, wherein:
the thickness dimension of said guide strip and the width dimension of said slit section are made to be quasi-equal to each other with great precision,
tapered sections to guide insertion of said guide strip are formed on both sides of the mouth of said slit section,
said guide strip is formed by forming said reinforcing member of said motherboard to have a cross-sectional shape roughly similar to an angular U-letter and then protruding the horizontal section of said reinforcing member toward said plug-in unit, and
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

18. The insertion guide mechanism as set forth in claim 1, wherein:
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

19. The insertion guide mechanism as set forth in claim 1, wherein:
the thickness dimension of said guide strip and the width dimension of said slit section are made to be quasi-equal to each other with great precision, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

20. The insertion guide mechanism as set forth in claim 1, wherein:
tapered sections to guide insertion of said guide strip are formed on both sides of the mouth of said slit section, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

21. The insertion guide mechanism as set forth in claim 1, wherein:
the thickness dimension of said guide strip and the width dimension of said slit section are made to be quasi-equal to each other with great precision,
tapered sections to guide insertion of said guide strip are formed on both sides of the mouth of said slit section, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

22. The insertion guide mechanism as set forth in claim 1, wherein:
said guide strip is formed by forming said reinforcing member of said motherboard to have a cross-sectional shape roughly similar to an angular U-letter and then protruding the horizontal section of said reinforcing member toward said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

23. The insertion guide mechanism as set forth in claim 1, wherein:
the thickness dimension of said guide strip and the width dimension of said slit section are made to be quasi-equal to each other with great precision,
said guide strip is formed by forming said reinforcing member of said motherboard to have a cross-sectional shape roughly similar to an angular U-letter and then protruding the horizontal section of said reinforcing member toward said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

24. The insertion guide mechanism as set forth in claim 1, wherein:
tapered sections to guide insertion of said guide strip are formed on both sides of the mouth of said slit section,
said guide strip is formed by forming said reinforcing member of said motherboard to have a cross-sectional shape roughly similar to an angular U-letter and then protruding the horizontal section of said reinforcing member toward said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

25. The insertion guide mechanism as set forth in claim 1, wherein:
the thickness dimension of said guide strip and the width dimension of said slit section are made to be quasi-equal to each other with great precision,
tapered sections to guide insertion of said guide strip are formed on both sides of the mouth of said slit section,
said guide strip is formed by forming said reinforcing member of said motherboard to have a cross-sectional shape roughly similar to an angular U-letter and then protruding the horizontal section of said reinforcing member toward said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

26. The insertion guide mechanism as set forth in claim 1, wherein:
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

27. The insertion guide mechanism as set forth in claim 1, wherein:
the thickness dimension of said guide strip and the width dimension of said slit section are made to be quasi-equal to each other with great precision,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

28. The insertion guide mechanism as set forth in claim 1, wherein:
tapered sections to guide insertion of said guide strip are formed on both sides of the mouth of said slit section,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

29. The insertion guide mechanism as set forth in claim 1, wherein:
the thickness dimension of said guide strip and the width dimension of said slit section are made to be quasi-equal to each other with great precision,
tapered sections to guide insertion of said guide strip are formed on both sides of the mouth of said slit section,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

30. The insertion guide mechanism as set forth in claim 1, wherein:
said guide strip is formed by forming said reinforcing member of said motherboard to have a cross-sectional shape roughly similar to an angular U-letter and then protruding the horizontal section of said reinforcing member toward said plug-in unit,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

31. The insertion guide mechanism as set forth in claim 1, wherein:
the thickness dimension of said guide strip and the width dimension of said slit section are made to be quasi-equal to each other with great precision,
said guide strip is formed by forming said reinforcing member of said motherboard to have a cross-sectional shape roughly similar to an angular U-letter and then protruding the horizontal section of said reinforcing member toward said plug-in unit,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

32. The insertion guide mechanism as set forth in claim 1, wherein:
tapered sections to guide insertion of said guide strip are formed on both sides of the mouth of said slit section,
said guide strip is formed by forming said reinforcing member of said motherboard to have a cross-sectional shape roughly similar to an angular U-letter and then protruding the horizontal section of said reinforcing member toward said plug-in unit,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

33. The insertion guide mechanism as set forth in claim 1, wherein:
the thickness dimension of said guide strip and the width dimension of said slit section are made to be quasi-equal to each other with great precision,
tapered sections to guide insertion of said guide strip are formed on both sides of the mouth of said slit section,
said guide strip is formed by forming said reinforcing member of said motherboard to have a cross-sectional shape roughly similar to an angular U-letter and then protruding the horizontal section of said reinforcing member toward said plug-in unit,
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit, and
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

34. The insertion guide mechanism as set forth in claim 1, wherein:
said reinforcing member is a warp preventive part provided on said motherboard.

35. The insertion guide mechanism as set forth in claim 1, wherein:
said reinforcing member is a warp preventive part provided on said motherboard, and
the thickness dimension of said guide strip and the width dimension of said slit section are made to be quasi-equal to each other with great precision.

36. The insertion guide mechanism as set forth in claim 1, wherein:
said reinforcing member is a warp preventive part provided on said motherboard, and
tapered sections to guide insertion of said guide strip are formed on both sides of the mouth of said slit section.

37. The insertion guide mechanism as set forth in claim 1, wherein:
said reinforcing member is a warp preventive part provided on said motherboard,
the thickness dimension of said guide strip and the width dimension of said slit section are made to be quasi-equal to each other with great precision, and
tapered sections to guide insertion of said guide strip are formed on both sides of the mouth of said slit section.

38. A sub-rack provided with a plug-in unit insertion guide mechanism which assists insertion of a plug-in unit for connection to a motherboard on a sub-rack, wherein:
said insertion guide mechanism comprises
a guide strip which is formed integrally with a reinforcing member provided on said motherboard and which extends toward said plug-in unit, and
a slit section which is provided on a printed wiring board which comprises said plug-in unit and into which said guide strip is to be inserted without any clearance.

39. The sub-rack as set forth in claim 38, wherein
said guide strip is to be inserted into the slit section of said printed wiring board without any clearance.

40. The sub-rack as set forth in claim 38, wherein
the thickness dimension of said guide strip and the width dimension of said slit section are made to be quasi-equal with great precision.

41. The sub-rack as set forth in claim 38, wherein
tapered sections to guide insertion of said guide strip are formed on both sides of the mouth of said slit section.

42. The sub-rack as set forth in claim 38, wherein
said guide strip is formed by forming said reinforcing member of said motherboard to have a cross-sectional shape roughly similar to an angular U-letter and then protruding the horizontal section of said reinforcing member toward said plug-in unit.

43. The sub-rack as set forth in claim 38, wherein
two of said guide strips are formed by protruding the upper and lower horizontal sections of said reinforcing member of a cross-sectional shape roughly similar to an angular U-letter, and two slit sections into which two of said guide strips are to be inserted are formed in said plug-in unit.

44. The sub-rack as set forth in claim 38, wherein
said guide strip is formed to have a length such that, if said plug-in unit should be misinserted, said guide strip will collide with said plug-in unit and said plug-in unit will thus be prevented from being inserted before the connector of said plug-in unit and the connector of said motherboard come into contact with each other.

45. The insertion guide mechanism as set forth in claim 1, wherein:
said reinforcing member is a warp preventive part provided on said motherboard.
